(19) United States
(12) Patent Application Publication
(10) Pub. No.: US 2026/0309939 A1
(43) Pub. Date: Oct. 8, 2026

(54) OPTICAL COMPONENT

(71) Applicant: NTT, Inc., Tokyo (JP)

(72) Inventors: Yusuke Nasu, Tokyo (JP); Yuriko Kawamura, Tokyo (JP); Yosuke Hinakura, Tokyo (JP)

(21) Appl. No.: 19/483,440

(22) PCT Filed: May 12, 2023
(86) PCT No.: PCT/JP2023/017972

§ 371 Date: Nov. 11, 2025

(51) Int. Cl. G02B 6/42

(52) U.S. Cl. CPC G02B 6/4225; G02B 6/4206; G02B 6/4227

(57) ABSTRACT

An optical component comprising a connection end face to which an optical fiber array is connected and an optical circuit unit is provided herein. The connection end face includes an optical input port and an optical output port. The optical circuit unit includes an optical circuit connected to the optical input port, an optical branching circuit including a first port connected to the optical circuit, a second port connected to the optical output port, a third port adjacent to the second port, and a fourth port adjacent to the first port, a first optical receiver connected to the third port, and a second optical receiver connected to the fourth port. The optical branching circuit branches light input from the first port and outputs the light from the second port and third port, and outputs light input from the second port from the fourth port.

### CROSS-REFERENCE TO RELATED APPLICATIONS

This application is a national phase entry of PCT Application No. PCT/JP2023/017972, filed on May 12, 2023, which application is hereby incorporated herein by reference.

### TECHNICAL FIELD

The present disclosure relates to an optical component which is used for optical communication, or the like, and in which an optical waveguide to which an optical fiber array is connected is formed.

### BACKGROUND

In an optical component in which an optical waveguide such as an optical circuit board is formed, an optical fiber is connected to each of an input optical waveguide and an output optical waveguide of the optical component in order to input and output an optical signal. FIG. 1 is a view for explaining a module 100 in related art configured as an optical transceiver. FIG. 1(a) illustrates an arrangement configuration of the module 100 as viewed from an upper surface, and FIG. 1(b) illustrates the arrangement configuration of the module 100 as viewed from a side surface. The module 100 includes an optical component 101 and an optical fiber array 102 connected to the optical component 101.

FIG. 1(a) illustrates arrangement of optical waveguides formed in the optical

### CROSS-REFERENCE TO RELATED APPLICATIONS

This application is a national phase entry of PCT Application No. PCT/JP2023/017972, filed on May 15, 2023, which application is hereby incorporated herein by reference.

### TECHNICAL FIELD

The present disclosure relates to an optical component which is used for optical communication, or the like, and in which an optical waveguide to which an optical fiber array is connected is formed.

### BACKGROUND

In an optical component in which an optical waveguide such as an optical circuit board is formed, an optical fiber is connected to each of an input optical waveguide and an output optical waveguide of the optical component in order to input and output an optical signal. FIG. 1 is a view for explaining a module 100 in related art configured as an optical transceiver. FIG. 1(a) illustrates an arrangement configuration of the module 100 as viewed from an upper surface, and FIG. 1(b) illustrates the arrangement configuration of the module 100 as viewed from a side surface. The module 100 includes an optical component 101 and an optical fiber array 102 connected to the optical component 101.

FIG. 1(a) illustrates arrangement of optical waveguides formed in the optical component 101 and respective functional components to which the optical waveguides are connected. The optical component 101 includes an optical circuit unit 103 (a portion surrounded by a dotted line in the drawing) in which an optical reception circuit 104, an optical modulator 105, an optical branching circuit 106, and an optical receiver 107 are arranged. An optical waveguide 108 connected to an input port is connected to the optical reception circuit 104, an optical waveguide 109 connected to an input port to which light from a light source for a component 101 and respective functional components to which the optical waveguides are connected. The optical component 101 includes an optical circuit unit 103 (a portion surrounded by a dotted line in the drawing) in which an optical reception circuit 104, an optical modulator 105, an optical branching circuit 106, and an optical receiver 107 are arranged. An optical waveguide 108 connected to an input port is connected to the optical reception circuit 104, an optical waveguide 109 connected to an input port to which light from a light source for a transmission signal is to be input is connected to the optical modulator, and an optical waveguide 110 connected to an output port is connected to one of output sides of the optical branching circuit 106. The optical modulator 105 and the optical branching circuit 106 are connected by an optical waveguide 111. In addition, the optical receiver 107 for detecting light intensity of an output signal from the optical modulator is connected to the other output side of the optical branching circuit 106 by an optical waveguide 112.

The optical receiver 107 is used to branch part of an optical modulated signal and monitor output intensity of the optical modulator. Thus, the optical branching circuit 106 is designed to branch a large amount of light to an optical output port side and branch only a minimum amount of light necessary for monitoring to the optical receiver side. For example, 5% of the light incident on the optical branching circuit 106 is branched to the optical receiver 107 side, and the remaining 95% of the light is branched to the optical waveguide 110 side. The output power of the optical circuit can be monitored by light intensity monitored by the optical receiver.

As the optical branching circuit 106, a directional coupler or a multimode interference coupler (MMI coupler) capable of branching part of light is used. The optical branching circuit only requires to be a branching circuit having one port on the input side and two ports on the output side, and thus, a one-input two-output MMI coupler, a two-input two-output MMI coupler in which one of the input ports is optically terminated, or a directional coupler has been used. Here, the optical termination means a circuit that absorbs or radiates light in the circuit so that input light is not reflected.

The optical fiber array 102 for inputting and outputting an optical signal is connected to the optical component 101 at a connection end face 113. The optical fiber array 102 includes optical fibers 114₁, 114₂, and 114₃, and an optical fiber block 115 in which these optical fibers 114₁ to 114₃ are sandwiched and fixed between a pressing plate 116 and a groove substrate 117. The optical fibers, the groove substrate, and the pressing plate are fixed by an adhesive 118. The optical component 101 and the optical fiber block 115 are fixed to each other at the connection end face 113 using an adhesive 119.

In the module 100 illustrated in FIG. 1, each of the optical waveguides 108, 109, and 110 of the optical component and the optical fibers 114₁ to 114₃ need to be coupled with low loss. Thus, when the optical fiber block is fixed to the optical component, highly accurate position adjustment of the optical waveguides and the optical fibers is required. In particular, in the position adjustment of the optical fiber array in which a plurality of optical fibers are arranged in an array like the module in FIG. 1, all the optical fibers cannot be connected to the respective optical waveguides with low loss unless not only an XY position in a connection plane but also a rotation direction (rotation axis θ orthogonal to the XY plane) of the optical fiber array is accurately adjusted.

In such position adjustment including the rotation direction of the optical fiber array, it is necessary to independently adjust positions of, that is, align the two optical fibers constituting the optical fiber array and the ports of the optical waveguides to which the optical fibers are to be respectively coupled.

As a method capable of adjusting the positions of the optical fibers and the optical waveguides with high accuracy, a method is known in which light is incident from the optical fibers on an optical circuit of an optical component, and relative positions between the optical fibers and the optical waveguides are adjusted so that the light intensity is maximized while the light intensity is monitored. The position adjustment between the optical fibers and the optical waveguides is performed using an alignment device. For example, position adjustment between the optical component 101 and the optical fiber array 102 illustrated in FIG. 1 is performed by attaching the optical component and the optical fiber block 115 to the alignment device, fixing one position, and moving the other position. Thus, in order to adjust the XY position and the θ rotation direction of the optical fiber array using this method, it is necessary to monitor intensity of light incident on the optical waveguides from at least two optical fibers among the optical fibers constituting the optical fiber array.

In the case of the optical component 101 illustrated in FIG. 1, intensity of light incident on the optical waveguide 108 connected to the optical input port can be monitored by the optical reception circuit 104. In addition, intensity of light incident on the optical waveguide 109 connected to the optical input port can be monitored by the optical receiver 107 by controlling and operating the optical modulator 105. It is therefore possible to perform alignment between the optical component 101 and the optical fiber array 102 in FIG. 1. However, in FIG. 1, in order to monitor the intensity of the light incident on the optical waveguides 108 and 109, it is necessary to control and operate the optical reception circuit 104 and the optical modulator 105. In addition, it is basically impossible to monitor the light incident on the optical waveguide 110 connected to the light output port of the optical component.

In order to use the above-described alignment method, a branching circuit is inserted into an input/output optical waveguide of an optical component, and part of light incident on the input/output optical waveguide is monitored by the optical receiver or reflected by a reflector. A module 200 of FIG. 2 is configured by connecting an optical component 201 and the optical fiber array 102. The optical component 201 includes the optical circuit unit 103 and the optical waveguides 108, 109, and 110 connected to the optical circuit unit. In addition, the optical fiber array 102 includes the optical fibers 114₁ to 114₃ connected to the optical waveguides 108, 109, and 110 connected to the optical circuit unit.

In the optical component 201 of FIG. 2, optical branching circuits 210 and 220 are provided in the optical waveguides 108 and 110 connected to the optical circuit unit. Thus, part of the light input to the optical waveguides 108 and 110 is branched and transmitted to the optical receivers or reflectors 211 and 221 connected to the optical branching circuits 210 and 220. As the optical receiver, for example, a Ge optical receiver, or the like, is used. As the reflector, for example, a mirror formed by depositing a metal film is used. In the configuration of FIG. 2, in a case where the optical receivers 211 and 221 are used, intensity of light input from the optical fibers 114₁ and 114₃ to the optical waveguides 108 and 110 to which the optical fibers 114₁ and 114₃ are connected can be monitored by the optical receivers 211 and 221 connected to the optical branching circuit. Further, in the configuration of FIG. 2, in a case where the reflectors 211 and 221 connected to the optical branching circuit are used, intensity of light input from the optical fibers 114₁ and 114₃ to the optical waveguides 108 and 110 to which the optical fibers 114₁ and 114₃ are connected can be monitored by separating intensity of reflected return light reflected by the reflectors 211 and 221 and returned to the optical fibers 114₁ and 114₃ by a circulator, or the like.

Thus, in FIG. 2, the position adjustment with the optical waveguide 108 or 110 can be independently performed while monitoring the intensity of the input light input from the optical fiber 114₁ or 114₃, so that the position adjustment in the XY direction and the θ-axis rotation direction can be performed with high accuracy.

In this manner, by inserting the branching circuit into the optical waveguides and monitoring part of the light incident on the optical waveguides by the optical receiver or reflecting the part of the light by the reflector, it is possible to monitor the intensity of the light incident on the optical waveguides through which the output signal from the optical circuit propagates and is emitted. Thus, even an optical component including only an optical modulator can perform alignment using the above-described method. In addition, in FIG. 2, the intensity of the light incident on the optical waveguides is monitored by the optical receiver arranged for alignment or the optical receiver connected to the optical fibers, so that it is not necessary to operate the optical circuit at the time of alignment work.

There is one in which an optical circuit for alignment for aligning an optical fiber array with optical waveguides of an optical component connected to the optical fiber array is provided separately from an optical circuit unit that executes an original function of the optical component (Patent Literature 1). FIG. 3 is a view for explaining a module 300 in the related art including an optical component 301 including an optical circuit for alignment in the optical component. FIG. 3(a) illustrates a state in which the alignment is performed using the optical circuit for alignment, and FIG. 3(b) illustrates a state in which the optical fiber array and the optical component are fixed together with the arrangement configuration viewed from an upper surface of the module 300.

The optical component 301 of the module 300 includes an alignment optical circuit unit 310 separately from the optical circuit unit 103. The alignment optical circuit unit 310 includes alignment optical waveguides 311 and 312 and optical receivers or optical reflectors 313 and 314 connected to the alignment optical waveguides 311 and 312. As the optical receiver, for example, a Ge optical receiver, or the like, is used. As the optical reflector, for example, a mirror formed by depositing a metal film is used. An interval between the alignment optical waveguides 311 and 312 is set to be the same as an interval between any two optical fibers of the optical fiber array. In the example illustrated in FIG. 3, the interval between the alignment optical waveguides is set so as to correspond to the optical fibers 114₁ and 114₃.

Procedure for connecting the optical fiber array 102 to the optical component 301 of the module 300 in FIG. 3 is as follows. As illustrated in FIG. 2(a), the alignment optical waveguide of the alignment optical circuit unit of the optical component 301 and the optical fiber array of the optical fiber block are aligned. In a case where the alignment optical circuit unit includes an optical receiver, intensity of light incident from the optical fibers 114₁ and 114₃ of the optical fiber block 115 is monitored by photocurrents of the optical receivers 313 and 314, respectively. In addition, in a case where the alignment optical circuit unit includes a reflector, the intensity of the light incident from the optical fibers 114₁ and 114₃ is monitored by separating intensity of the reflected return light reflected by the reflectors 312 and 313 and returned to the optical fibers 114₁ and 114₃ by a circulator, or the like.

Thus, as illustrated in FIG. 3(a), it is possible to independently adjust the positions of the two optical fibers and the alignment optical waveguides while monitoring the input light intensity input from the optical fibers. Thus, in FIG. 3(a), position adjustment of the optical fiber array and the alignment optical waveguides in the XY direction and the θ-axis rotation direction can be performed with high accuracy.

After completion of the alignment of the optical fiber array at the position of the alignment optical circuit unit in FIG. 3(a), the optical fiber block 115 is moved by a distance between the alignment optical waveguides 311 and 312 and the optical waveguides 108 and 110 at position where the optical fiber array is actually fixed as in FIG. 3(b), and is fixed to the optical component at the position by an adhesive being cured. Note that, as the distance by which the optical fiber block is moved, a distance between the alignment optical waveguides and the optical waveguides of the optical circuit unit on the connection end face determined at the design stage, or the like, is used.

In the configuration of FIG. 3, an optical branching circuit for alignment and an optical receiver or a reflector are provided separately from the optical circuit unit 103. Thus, in the configuration of FIG. 3, the optical branching circuit for alignment is not added to the optical circuit unit 103 as in the configuration of FIG. 2. Thus, degradation of performance of the optical circuit unit such as loss of input light to the optical circuit unit or output light from the optical circuit unit due to the optical branching circuit for alignment does not occur.

FIG. 4 is an example of a configuration in the related art that does not require movement of the optical fiber block from the alignment position to the fixing position. Alignment optical circuit units 410 and 420 of an optical component 401 in FIG. 4 include optical receivers or reflectors 412 and 422, respectively, similarly to the alignment optical circuit unit of FIG. 3. Thus, in a similar manner to the alignment optical circuit unit of FIG. 3, intensity of light input to the alignment optical waveguides 411 and 421 can be monitored.

In the configuration of FIG. 4, the positions of alignment optical fibers 431 and 432 and alignment optical waveguides 411 and 421 can be adjusted while monitoring the intensity of the input light, so that the position adjustment of the optical fiber array in the XY direction and the θ-axis rotation direction can be performed with high accuracy. In the optical fiber array 402 of FIG. 4, the optical fibers 114₁ to 114₃ connected to the optical waveguides 108, 109 and 110 of the optical circuit unit are arranged to be sandwiched between the alignment optical fibers 431 and 432. Thus, by adjusting the positions of the alignment optical fibers 431 and 432 with the alignment optical waveguides 411 and 421, the positions on the XY axis and the θ axis of the optical fiber block 430 and the optical component 401 are adjusted with high accuracy. As a result, the optical fibers 114₁ to 114₃ and the optical waveguides 108, 109, and 110 are also adjusted with high accuracy. As described above, in the configuration of FIG. 4, the optical fiber block does not move from when the alignment is completed until when the optical fiber array is fixed as in the configuration of FIG. 3, so that there is no influence of the movement of the optical fiber array.

For example, even in the case of a module 500 in which the optical input port and the optical output port connected to an optical modulator 505 are arranged on different sides of the optical component as illustrated in FIG. 5, or in a case where the optical input port and the optical output port are arranged on the same side of the optical component, if the optical fibers connected to the respective ports are fixed to individual optical fiber blocks, as illustrated in FIG. 5, it is possible to adjust the position of the module 500 including the optical component 501 including only the optical modulator. In the configuration of FIG. 5, an optical fiber 510 and an optical fiber 511 are fixed to different optical fiber blocks, so that the positions of the optical fiber 510 and the optical fiber 511 can be adjusted independently.

The alignment of the optical fibers 510 and 511 in FIG. 5 is performed by the following procedure. An optical fiber block 503 on the optical output port side is fixed in a state where a certain amount of light is coupled, and the light intensity of the optical fiber 511 is monitored. In this state, the optical fiber 510 of an optical fiber block 502 on the optical input port side is aligned so that the light intensity is maximized, and the position of the optical fiber block 502 is determined. Thereafter, it is possible to perform alignment by fixing the optical fiber block 502 on the optical input port side and adjusting the position of the optical fiber 511 of the optical fiber block 503 so that the light intensity is maximized while monitoring the light intensity of the optical fiber 511. However, in a case where two optical fibers are fixed to the same optical fiber block as illustrated in FIG. 1, a position of one optical fiber cannot be moved while a position of the other optical fiber is fixed, so that this alignment method cannot be applied.

The configuration of FIG. 1 described above cannot monitor the intensity of light input to the optical waveguide connected to the optical output port output from the optical circuit. For this reason, to align the optical fiber array, a port connected to an optical waveguide capable of monitoring the intensity of light, such as separately including an optical input port for an optical reception circuit, is required. In addition, in order to monitor the intensity of the light incident on the optical circuit from the input optical waveguide connected to the optical input port, it is necessary to control and operate the optical circuit such as the optical modulator. However, this control is complicated procedure, and thus, it is complicated to operate the optical modulator to align the optical fibers.

In the configuration illustrated in FIG. 2, the light input to the optical waveguide connected to the output port of the optical circuit can be monitored, but an extra optical branching circuit for alignment, which is not necessary for the function of the optical component, is inserted into the optical circuit unit, which causes problems such as optical loss and sensitivity reduction due to the optical branching circuit.

The configurations of FIGS. 3 and 4 do not affect the function of the optical component. However, the alignment optical circuit needs to be separately provided in addition to the circuit unit. In addition, in the configurations of FIGS. 3 and 4, the position adjustment of the optical fibers and the optical waveguides is not performed using the optical fiber connected to the input/output port to the optical component, but is only performed with the optical fibers and the optical waveguides to be used only at the time of alignment that are not used at the time of normal use of the optical component. Thus, in a case where there is a manufacturing error in the optical fiber array or the optical waveguides, there is a problem that connection with low loss cannot be implemented due to the influence. Further, the configuration of FIG. 3 has a problem that although the alignment optical fibers are not required, the optical fiber block needs to be moved to the fixing position after the alignment in the alignment optical circuit unit, and an error occurs due to the movement. In addition, although the configuration of FIG. 4 does not require movement of the optical fiber block, it is necessary to add an extra optical fiber for alignment to the optical fiber array, and there is a problem from the viewpoint of cost and size.

As illustrated in FIG. 5, it is conceivable to fix the optical fibers connected to the optical input port and the optical output port to different optical fiber blocks, but the number of components such as the optical fiber block increases, and the size in a module state including the optical circuit and the optical fiber array increases. In addition, the number of components increases, which causes a problem that costs increases.

### CITATION LIST

### Patent Literature

Patent Literature 1: JP 2018-77276 A

### SUMMARY

An object of the present disclosure is to provide an optical component that solves the above problems.

In other words, an object of the present disclosure is to provide an optical component that makes it possible to monitor intensity of light input to an optical waveguide connected to an optical output port that cannot be monitored in the related art, and makes it possible to align an optical fiber array including an XY direction and a θ-axis rotation direction without adding an optical branching circuit for alignment, an optical circuit, or an optical fiber.

In addition, an object of the present disclosure is to provide an optical component that makes it possible to monitor intensity of light input to an optical waveguide connected to an optical output port without adding an optical branching circuit for alignment to an optical circuit.

Furthermore, an object of the present disclosure is to provide an optical component that does not require control operation of an optical circuit such as an optical modulator and can be aligned with an optical fiber array.

As described in each embodiment below, the present disclosure is an optical component that makes it possible to execute alignment of an optical fiber array by monitoring intensity of light from an optical fiber connected to an optical output port without using a branching circuit for alignment.

An optical component according to an embodiment of the present disclosure is an optical component including a connection end face to which an optical fiber array is connected and an optical circuit unit, in which the connection end face includes an optical input port and an optical output port, the optical circuit unit includes an optical circuit connected to the optical input port, an optical branching circuit including first to fourth ports, the optical branching circuit branching light input from the first port connected to the optical circuit to output the light from the second port and the third port adjacent to each other and outputting light input from the second port connected to the optical output port from the fourth port adjacent to the first port, a first optical receiver connected to the third port of the optical branching circuit, and a second optical receiver connected to the fourth port of the optical branching circuit.

### BRIEF DESCRIPTION OF THE DRAWINGS

FIG. 1 is a view for explaining an optical module in related art.

FIG. 2 is a view for explaining an optical module including an optical branching device for alignment in the related art.

FIG. 3 is a view for explaining an optical module including an optical circuit for alignment in the related art.

FIG. 4 is a view for explaining an optical module including an optical fiber for alignment and an optical circuit in the related art.

FIG. 5 is a view for explaining an optical module in which an optical input port and an optical output port in the related art are arranged on different sides.

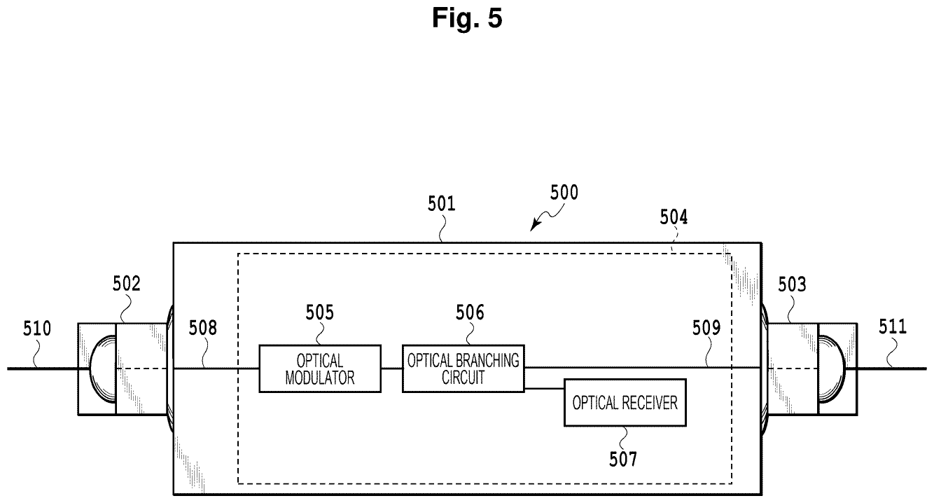

FIG. 6 is a view illustrating an arrangement configuration of a module including an optical component and an optical fiber array according to a first embodiment of the present disclosure.

FIG. 7 is a view for explaining an alignment method of the first embodiment of the present disclosure.

FIG. 8 is a view illustrating an arrangement configuration of a module including an optical component and an optical fiber array according to a second embodiment of the present disclosure.

FIG. 9 is a view illustrating an arrangement configuration of a module including an optical component and an optical fiber array according to a third embodiment of the present disclosure.

FIG. 10 is a view illustrating an arrangement configuration of a module including an optical component and an optical fiber array according to a modification of the third embodiment of the present disclosure.

FIG. 11 is a view illustrating an arrangement configuration of a module including an optical component and an optical fiber array according to a fourth embodiment of the present disclosure.

### DETAILED DESCRIPTION OF ILLUSTRATIVE EMBODIMENTS

Hereinafter, embodiments of the present disclosure will be described in detail with reference to the drawings. Note that the following description is an example, and some configurations may be modified without departing from the gist of the present disclosure. The same or similar reference numerals denote the same or similar components, and repetitive explanation thereof will not be made in some cases. The numerical values in the following description are exemplary, and the present disclosure may be implemented using other numerical values without departing from the gist of the present disclosure.

The present disclosure focuses on an optical branching circuit provided for monitoring intensity of light output from an optical circuit, and an optical receiver for alignment is additionally used in the optical branching circuit, thereby making it possible to monitor intensity of light incident on an optical waveguide connected to an optical output port.

### First Embodiment

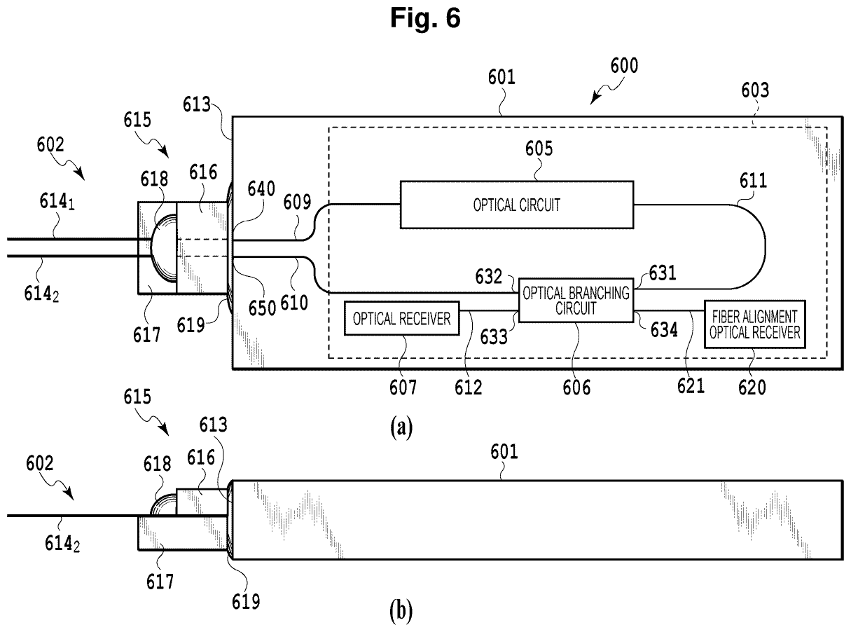

FIG. 6 is a view illustrating an arrangement configuration of a module 600 including an optical component 601 and an optical fiber array 602 according to a first embodiment of the present disclosure. FIG. 6(a) illustrates the arrangement configuration of the module 600 as viewed from an upper surface, and FIG. 6(b) illustrates the arrangement configuration of the module 600 as viewed from a side surface.

The optical component 601 according to the first embodiment includes a planar optical waveguide including a clad layer and a core formed on a planar substrate and an optical functional component integrated on the planar substrate. In the present disclosure, the optical component 601 is an optical circuit including a silicon substrate, a core, and upper and lower clad layers, but each layer may be formed using a dielectric material such as quartz-based glass, silicon nitride, or an indium phosphide material, a semiconductor material such as silicon or germanium, or the like.

FIG. 6(a) illustrates arrangement of the optical waveguides formed in the optical component 601 and respective functional components to which the optical waveguides are connected. The optical component 601 includes an optical circuit unit 603 in which an optical circuit 605, an optical branching circuit 606, and an optical receiver 607 are arranged. The optical branching circuit 606 is a two-input two-output branching circuit that includes first to fourth ports, branches light input from a first port 631 into a second port 632 and a third port 633 adjacent to each other, and branches light input from the second port 632 into a first port 631 and a fourth port 634 adjacent to each other and outputs the light. An optical waveguide 609 connected to an optical input port 640 of a connection end face 613 is connected to the optical circuit 605, and an optical waveguide 610 connected to an optical output port 650 of the connection end face 613 is connected to the second port 632 of the optical branching circuit 606. The optical circuit 605 and the first port 631 of the optical branching circuit 606 are connected by an optical waveguide 611. In addition, to a third port 633 of the optical branching circuit 606, the optical receiver 607 for detecting light intensity of the output signal from the optical circuit 605 as a first optical receiver is connected by an optical waveguide 612. Then, a fiber alignment optical receiver 620, which is a second optical receiver, is connected to the fourth port 634 of the optical branching circuit 606 by an optical waveguide 621.

An optical fiber array 602 for inputting and outputting an optical signal is connected to the optical component 601 at an optical input/output port of the connection end face 613. The optical fiber array 602 includes optical fibers 641₁ and 641₂, and an optical fiber block 615 in which the optical fibers 641₁ and 641₂ are sandwiched and fixed between a pressing plate 616 and a groove substrate 617. The optical fibers, the groove substrate, and the pressing plate are fixed by an adhesive 618. The optical component 601 and the optical fiber block 615 are fixed to each other at the connection end face 613 using an adhesive 619. As the adhesive, an ultraviolet curable resin, a thermosetting resin, or the like, can be used.

Assuming that the optical circuit 605 is a circuit for optical transmission, the optical circuit unit 603 often includes an optical modulator. Thus, in the following description, in order to facilitate the description, a case where the optical circuit 605 is an optical modulator will be described as an example. The modulator may be an appropriate circuit according to a modulation scheme such as intensity modulation or phase modulation. However, the optical modulator is exemplified for the sake of description, and in the present embodiment, the optical circuit is only required to be capable of outputting light correlated with intensity of input light other than the modulator.

In an alignment step of the optical fiber array, light input from the optical fiber 6141 is incident on the optical circuit via an optical input port 640. In a case where the optical fibers and the optical waveguides are aligned, unmodulated light using a tunable laser, or the like, as a light source is used as the light incident on the optical fiber. The light modulated by the optical circuit 605 is incident on the first port 631 of the optical branching circuit 606 and branched into the optical waveguide 610 connected to the second port 632 and the optical waveguide 612 connected to the third port 633.

As described above, the optical receiver 607 that monitors output light of the optical circuit such as the optical modulator is used to branch part of the output light of the optical circuit and monitor the intensity thereof. The optical branching circuit 606 of the present embodiment is designed to branch a large amount of light to the second port 632 on the optical output port side and branch only minimum light necessary for monitoring to the third port 633 on the optical receiver side. For example, it is designed to branch 5% of light incident on the optical branching circuit 606 to the third port on the optical receiver 607 side and branch the remaining 95% of light to the second port on the optical waveguide 610 side. As the optical branching circuit, a two-input two-output MMI coupler or a directional coupler can be used.

In the related art, the optical branching circuit used for this application has one port on the input side and two ports on the output side, but in the present embodiment, a two-input two-output optical branching circuit is used. Further, in the optical branching circuit 606 of the present embodiment, the fiber alignment optical receiver 620 is connected as a second optical receiver to the optical waveguide 621 connected to the fourth port 634 of the optical branching circuit.

Part of the light input from the optical circuit 605 to the first port 631 of the optical branching circuit 606 is branched into the optical receiver 607 and is used to monitor output power. When the completed module 600 is used, the fiber alignment optical receiver 620 is not used. Due to the specifications of the optical transceiver, light incident on the optical output port on the transmission side should not be reflected in the optical circuit and emitted as return light from the optical output port. It is therefore desirable that the fiber alignment optical receiver 620 has less reflection. Examples of the optical receiver with less reflection include an integrated optical receiver using a germanium-based material. Further, a boundary surface between the optical waveguide 621 and the fiber alignment optical receiver 620 is inclined so as not to be perpendicular to a propagation direction of light so that reflected light at the boundary surface does not return to the optical waveguide.

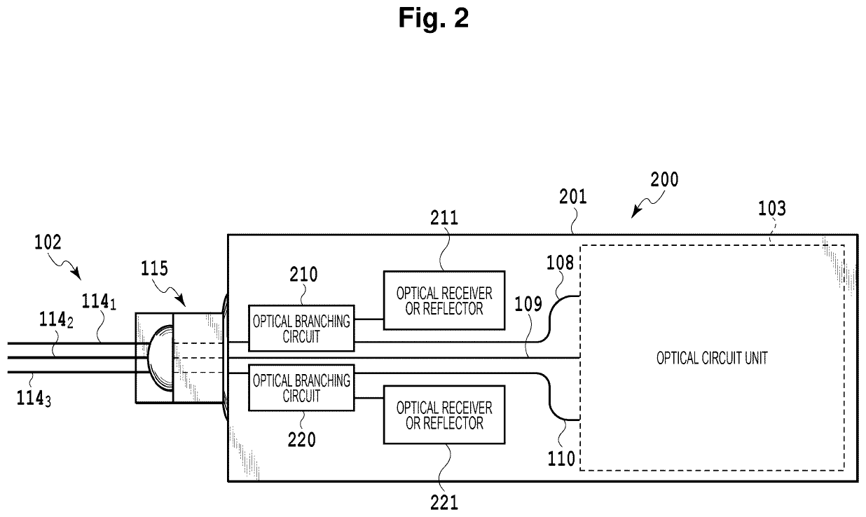

If light is incident on the optical output port 650 from the optical fiber 6142, the light is branched from the optical waveguide 610 to the optical waveguide 621 by the optical branching circuit 606 and is incident on the fiber alignment optical receiver 620. Thus, according to the present embodiment, it is possible to monitor intensity of light incident on the optical waveguide 610 connected to the optical output port 650 by the fiber alignment optical receiver 620 without newly adding an optical branching circuit for alignment. As described above, the optical component 601 of the present embodiment uses the optical branching circuit included in the optical circuit for power monitoring, and thus, no loss occurs due to insertion of the optical branching circuit for alignment as in the configuration of FIG. 2.

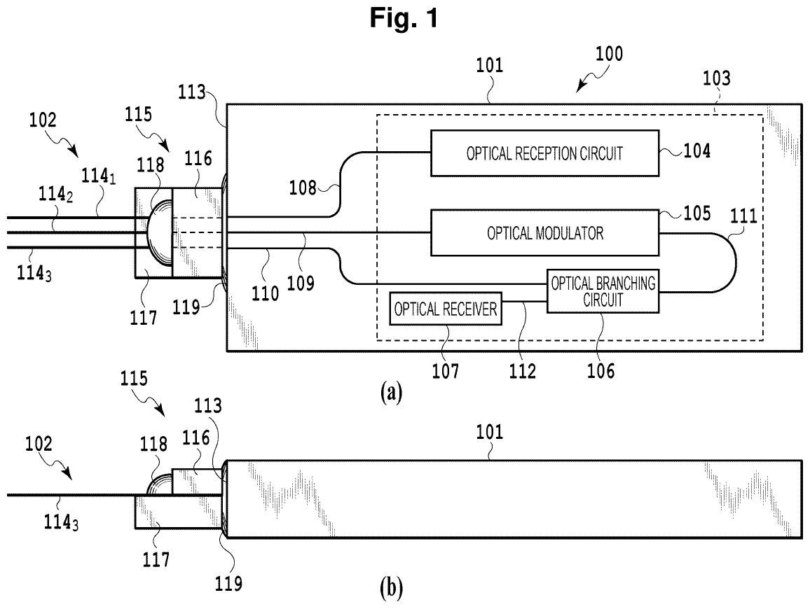

The intensity of the light incident on the optical waveguide 609 connected to the optical input port 640 can be monitored by the optical receiver 607 for power monitoring of the optical circuit by controlling the optical circuit to operate as in the related art. Thus, the optical component 601 of the present embodiment can perform alignment using only the optical fiber connected to the optical input/output port of the optical circuit, so that, even in a case where the optical reception circuit is not provided as illustrated in FIG. 1, alignment of the optical fiber array in the XY position and the θ-axis rotation direction can be performed with high accuracy.

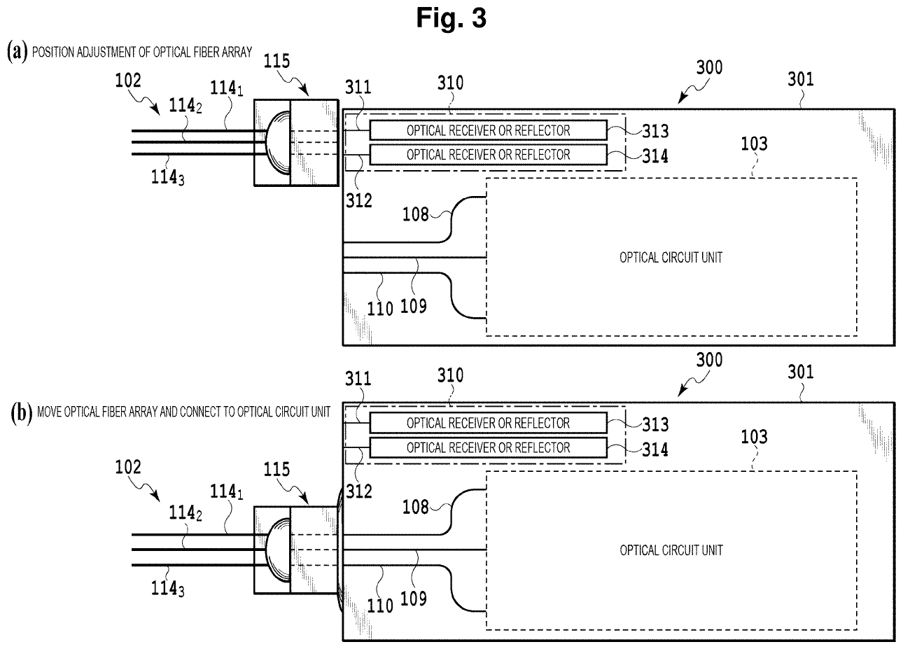

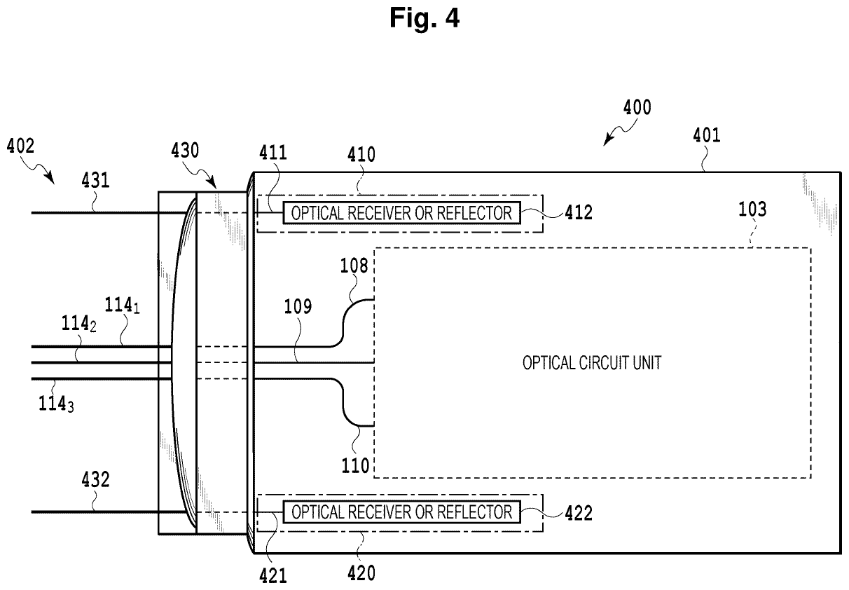

In addition, the optical component 601 of the present embodiment can perform alignment of an optical fiber connected to the optical input/output port to be used in normal use of the optical component. It is therefore possible to solve the problem of the influence of a manufacturing error of the optical fiber array for alignment and the optical waveguides in the configurations of FIGS. 3 and 4 described above.

### Alignment Method of Optical Component and Optical Fiber Array of First Embodiment

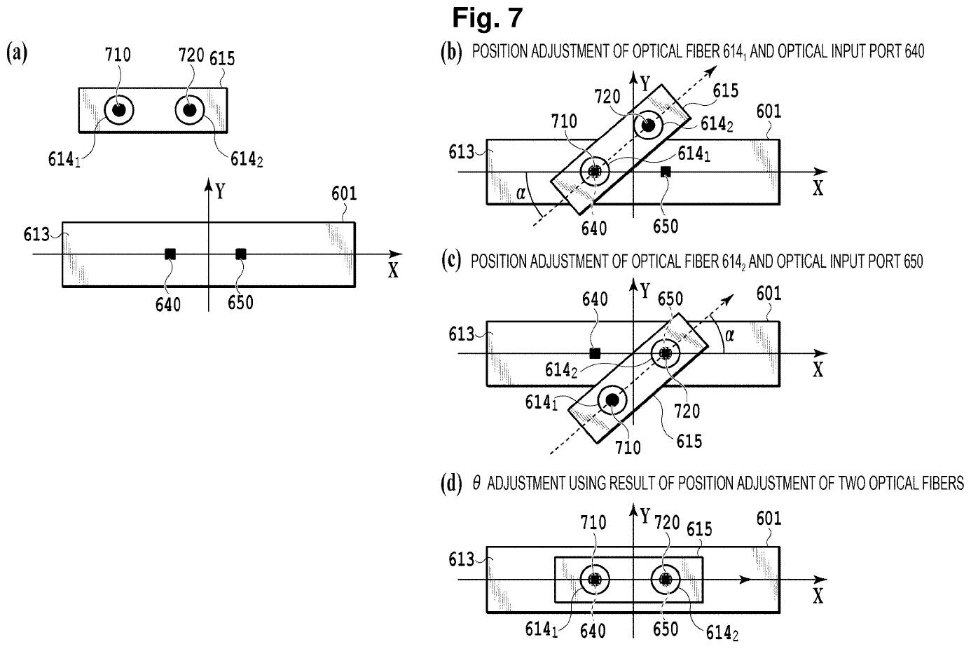

With reference to FIG. 7, an alignment method when the optical fiber array is connected to the optical component 601 according to the present embodiment will be described. The optical fiber array alignment method of the first embodiment is characterized by including a step of aligning an optical fiber connected to the optical output port of the optical circuit by using the optical component of the first embodiment. In connecting the optical component and the optical fiber array, the alignment is performed using a known alignment device. The alignment of the optical fiber array is performed by attaching the optical component and the optical fiber block to the alignment device, fixing a position of one of the optical component and the optical fiber block, and adjusting a position of the other.

FIG. 7 schematically illustrates a positional relationship between the optical component 601 and the optical fiber block 615 when the optical component 601 of FIG. 6 is viewed from the connection end face 613 side. FIG. 7(a) illustrates a schematic structure of each of the optical component 601 and the optical fiber block 615. On the connection end face 613 of the optical component 601, the optical input port 640 connected to the optical waveguide 609 and the optical output port 650 connected to the optical waveguide 610 are schematically illustrated. In the optical fiber block 615, the optical fibers 6141 and 6142 and cores 710 and 720 thereof are schematically illustrated.

FIG. 7(b) illustrates a state in which positions of the optical fiber 6141 and the optical input port 640 are adjusted in a first step. Here, a case where the optical component 601 is fixed and the optical fiber block 615 is relatively moved will be described.

The first step is a step of aligning a first optical fiber. In the first step, light is incident from the first optical fiber connected to the optical input port of the optical circuit, and a position of the optical fiber block is adjusted so that the light intensity is maximized. In this event, the intensity of the light incident on the optical input port of the optical circuit is monitored by the optical receiver 607 for power monitoring of the optical circuit by controlling the optical circuit to operate.

Specifically, while the intensity of the light incident on the optical fiber 6141 is monitored by a photocurrent of the optical receiver 607, the optical fiber block 615 is moved in the XY direction along the connection end face 613 of the optical component 601 and adjusted to a position where the light intensity is maximized. Then, the position of the optical fiber block at which the light intensity is maximized is recorded. This position of the optical fiber block is an optimum position of the optical fiber 6141. In this event, the optical circuit 605 is controlled to operate so as to output light having intensity corresponding to the intensity of the input light.

In a state in which adjustment is performed so that the light intensity is maximized in the first step, a relative position between the optical fiber 6141 and the optical input port 640 is optimally adjusted as illustrated in FIG. 7(b). The position of the optical fiber block can be recorded, for example, in the coordinate system of the alignment device. FIG. 7(b) illustrates a state in which the optical fiber array deviates by an angle α in the θ rotation direction.

A second step is a step of aligning a second optical fiber. In the second step, light is incident from the second optical fiber connected to the optical output port of the optical circuit, and a position of the optical fiber block in the XY direction is adjusted so that the light intensity is maximized. In this event, the intensity of the light incident on the optical output port of the optical circuit is monitored by the fiber alignment optical receiver.

Specifically, while light is incident on the optical fiber 6142 and the intensity of the light incident on the optical fiber 6142 is monitored by a photocurrent of the fiber alignment optical receiver 620, the optical fiber block 615 is moved only in the XY direction from a state in which positions of the optical fiber 6141 and the optical input port 640 are adjusted, and adjusted to a position where the light intensity is maximized. Then, the position of the optical fiber block at which the light intensity is maximized is recorded. This position of the optical fiber block is an optimum position of the optical fiber 6142. FIG. 7(c) illustrates an alignment state of the optical fiber 6142 and the optical output port 650.

The state in which adjustment is performed so that the light intensity is maximized in the second step is a state in which a relative position between the optical fiber 6142 and the optical output port 650 is optimally adjusted as illustrated in FIG. 7(c).

A third step is a step of calculating a deviation amount of the optical fiber array in the θ-axis rotation direction based on the position of the first optical fiber block obtained in the first step and the position of the second optical fiber block obtained in the second step.

Specifically, a relative position (vector) between the position recorded in the first step and the position recorded in the second step on the XY plane is calculated. This relative position occurs due to an angular deviation in the θ-axis rotation direction between the optical component 601 and the optical fiber block 615 in the states of FIG. 7(b) and 7(c). Thus, an angle α, which is the deviation amount in the θ-axis rotation direction, can be obtained through calculation based on the relative position. In a case where the deviation amount in the θ-axis rotation direction is 0, the relative positions also become equal.

A fourth step is a step of rotating in the θ-axis direction by the deviation amount in the θ-axis rotation direction obtained in the third step. Specifically, from the state in FIG. 7(c), the optical fiber block is rotated by a deviation amount α in the θ-axis rotation direction and moved to the state in FIG. 7(d).

In order to perform position adjustment with higher accuracy, the first to fourth steps may be repeated a plurality of times.

### Second Embodiment

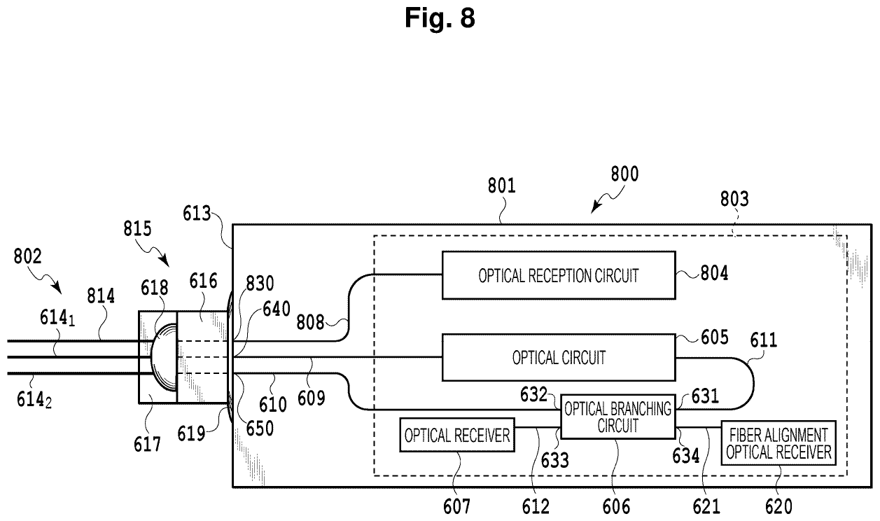

Next, a second embodiment of the present disclosure will be described with reference to FIG. 8. FIG. 8 is a view illustrating an arrangement configuration of a module 800 including an optical component 801 and an optical fiber array 802 according to the second embodiment of the present disclosure.

FIG. 8 illustrates arrangement of optical waveguides formed in the optical component 801 according to the second embodiment and respective functional components to which the optical waveguides are connected. The optical component 801 of the second embodiment is different from the optical component 601 of the first embodiment in that an optical circuit unit 803 further includes an optical reception circuit 804 and an optical waveguide 808 connected to the optical reception circuit. In addition, the optical fiber array 802 is different from the optical fiber array 602 of the first embodiment in that an optical fiber 814 corresponding to the optical waveguide 808 is provided. The connection end face 613 of the optical component 801 further includes an optical input port 830 to which the optical waveguide 808 is connected. In FIG. 8, components denoted by the same reference numerals as those in FIG. 6 are the same as those in FIG. 6, and thus, description thereof is omitted here.

As described in the example in the related art of FIG. 1, the optical reception circuit demodulates input light and converts the light into an electrical signal, and can monitor light intensity. The optical component 801 of the present embodiment can perform alignment of the optical fiber array while monitoring the intensity of light input from the optical fiber 814 and the optical fiber 6142 to the optical waveguides 808 and 610.

In other words, in a case where the optical component 801 of the second embodiment is used as an alignment method of the second embodiment, the first step of the alignment method of the first embodiment described with reference to FIG. 7 can be performed on the optical fiber connected to the optical input port of the optical reception circuit. Other steps of the alignment method are performed by the respective steps described in FIG. 7.

According to the alignment method of the second embodiment, in the alignment of the optical fiber array, it is not necessary to monitor the intensity of the light incident on the optical circuit from the optical fiber 6141 as in the first embodiment. Thus, the optical component 801 according to the second embodiment enables simple alignment of the optical fiber array without operating an optical circuit such as an optical modulator at the time of alignment of the optical fiber array.

### Third Embodiment

In recent years, an optical modulator for polarization multiplexing is sometimes used in order to increase transmission capacity. For example, polarization multiplexing coherent transmission, or the like, is used. In a third embodiment, an optical modulator for polarization multiplexing that enables polarization multiplexing coherent transmission is provided in an optical circuit unit. In the third embodiment, similarly to the first embodiment, an optical branching circuit to be used for power monitoring of output light of an optical modulator is used to monitor intensity of light input to an optical waveguide connected to an optical output port.

In the third embodiment, the optical circuit includes a first optical modulator and a second optical modulator, and the optical circuit unit is configured to include, as the optical branching circuit, a first optical branching circuit and a second optical branching circuit corresponding to the first optical modulator and the second optical modulator, respectively. Further, a polarization synthesizer that polarization-synthesizes the light from the first optical branching circuit and the light from the second optical branching circuit is further provided.

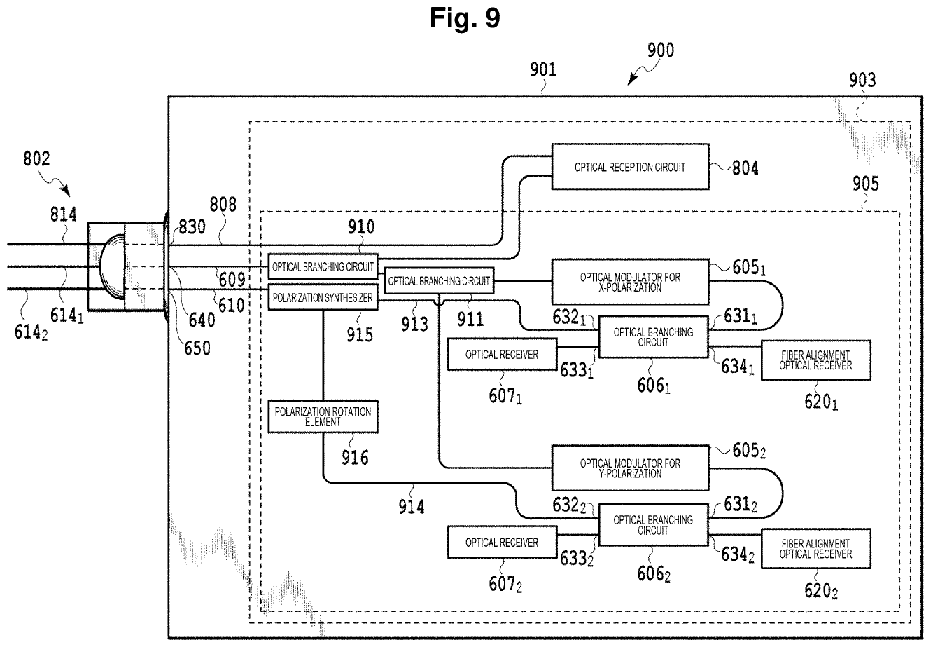

FIG. 9 is a view illustrating an arrangement configuration of a module 900 including an optical component 901 and the optical fiber array 802 according to the third embodiment. FIG. 9 illustrates arrangement of the optical waveguides formed in the optical component 901 and respective functional components to which the optical waveguides are connected. The optical component 901 of the third embodiment is different from that of the second embodiment in that an optical circuit of an optical circuit unit 903 includes a first optical modulator 605₁ for X-polarization and a second optical modulator 605₂ for Y-polarization of an optical transmission circuit 905. In FIG. 9, components denoted by the same reference numerals as those in FIGS. 6 and 8 are the same as those in FIGS. 6 and 8, and thus, description thereof is omitted here.

The input light from the optical waveguide 609 connected to the optical transmission circuit 905 is branched into the optical reception circuit 804 and an optical branching circuit 911 by an optical branching circuit 910. In the polarization multiplexing coherent transmission, a transmission optical signal input to the optical transmission circuit is used as local light in the optical reception circuit, and thus, the transmission optical signal is also input to the optical reception circuit via the optical branching circuit 910. The input light from the optical waveguide 609 is branched by the optical branching circuit 910, further branched by the optical branching circuit 911, and input to the optical modulator 605₁ for X-polarization and the optical modulator 605₂ for Y-polarization. This light is modulated by the respective optical modulators 605₁ and 605₂. The light modulated and output by each of the optical modulators 605₁ and 605₂ is branched into optical waveguides 913 and 914 by optical branching circuits 606₁ and 606₂, respectively, the X-polarization modulated signal of the optical waveguide 913 and the Y-polarization modulated signal of the optical waveguide 914 are synthesized by a polarization synthesizer 915, and the synthesized signal propagates through the optical waveguide 610 and is output as an optical modulated signal of the optical circuit from the optical output port 650. A polarization rotation element 916 is arranged in one of the optical waveguides 913 and 914, and one polarized wave is rotated by the polarization rotation element and then synthesized by the polarization synthesizer 915.

Similar to the optical circuit 605 of FIG. 8, the optical modulators 605₁ and 605₂ are respectively connected to the first input ports 631₁ and 631₂ of the optical branching circuits 606₁ and 606₂. In each of the optical branching circuits 606₁ and 606₂, similarly to the optical branching circuit 606 of FIG. 8, the fiber alignment optical receivers 620₁ and 620₂ are respectively connected to the fourth ports 634₁ and 634₂, and the optical receivers 607₁ and 607₂ for monitoring optical output power are connected to the third ports 633₁ and 633₂, respectively.

Similarly to the embodiment of FIG. 8, the optical branching circuit 606, the optical receiver 607, and the fiber alignment optical receiver 620 can also be arranged in the optical waveguide 610. However, in a case where a silicon material is used for a waveguide called silicon photonics, the optical branching circuit operates with single polarization. The polarization-multiplexed light propagates in the optical waveguide 610 from the polarization synthesizer 915 to the optical output port, and thus, it may be difficult to monitor the output light intensity of the optical circuit in the optical branching circuit that operates only with single polarization. Thus, in the optical component 901 according to the present embodiment, the optical branching circuits 606₁ and 606₂ are arranged between the polarization synthesizer 915 and the optical modulators 605₁ and 605₂ through which the modulated signal of only single polarization propagates. Specifically, as illustrated in FIG. 9, the second output ports 632₁ and 632₂ of the optical branching circuits 606₁ and 606₂ are connected to the polarization synthesizer, and the light from the optical branching circuits 606₁ and 606₂ is subjected to polarization synthesis. Thus, in the present embodiment, an optical branching circuit that operates only with single polarization can be used.

In the present embodiment, the fiber alignment optical receivers 620₁ and 620₂ are arranged in the fourth ports 634₁ and 634₂ of the optical branching circuits 606₁ and 606₂, respectively. However, even if the fiber alignment optical receivers are arranged in only one of the ports, it is possible to detect the intensity of the light incident on the optical waveguide 610. However, the light incident on the optical waveguide 610 at the time of alignment of the optical fiber is polarization-separated into an X polarized wave and a Y polarized wave by the polarization synthesizer 915 and is incident on each fiber alignment optical receiver. Thus, the light intensity monitored by the fiber alignment optical receiver 620₁ or 620₂ fluctuates if the polarization of the input light fluctuates. On the other hand, in a case where the fiber alignment optical receivers are arranged on both sides, it is possible to eliminate influence of the polarization fluctuation of the input light by summing currents flowing through the two fiber alignment optical receivers and monitoring the light intensity.

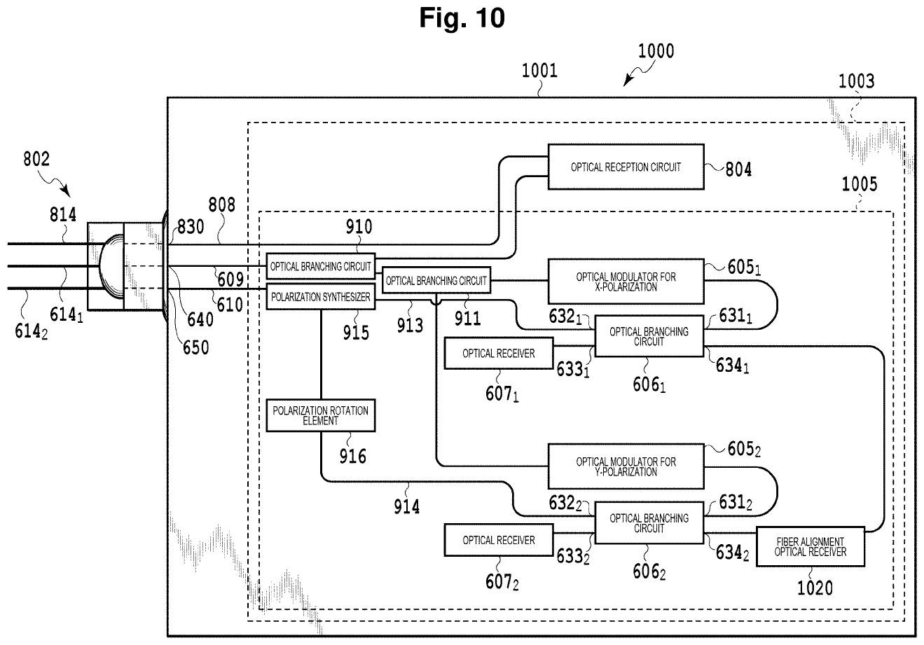

Next, a modification of the third embodiment will be described with reference to FIG. 10. FIG. 10 is a view illustrating an arrangement configuration of a module 1000 including an optical component 1001 and the optical fiber array 802 according to the third embodiment. FIG. 10 illustrates arrangement of the optical waveguides formed in the optical component 1001 and respective functional components to which the optical waveguides are connected. Portions 1003 and 1005 surrounded by chain lines in the drawing correspond to the optical circuit unit 903 and the optical transmission circuit 905 in FIG. 9, respectively. This modification is different from the optical component 901 of FIG. 9 in that one common fiber alignment optical receiver 1020 is connected to the fourth ports 634₁ and 634₂ of the optical branching circuits 606₁ and 606₂ for polarization of the optical circuit unit 1003. Other configurations denoted by the same reference numerals as those in FIG. 9 are the same as those in FIG. 9, and thus the description thereof will be omitted here.

In this modification, the intensity of the light from the optical branching circuits 606₁ and 606₂ is monitored using the two-input fiber alignment optical receiver 1020, and thus, the light branched by the polarization synthesizer 915 propagates through a path on the X-polarization side (path including the optical waveguide 913) and a path on the Y-polarization side (path including the optical waveguide 914), respectively, but is received by one common fiber alignment optical receiver 1020. Thus, the processing of summing the photocurrents of the two fiber alignment optical receivers 620₁ and 620₂ as in the configuration of FIG. 9 becomes unnecessary. Also according to this modification, it is possible to easily monitor intensity of light incident on the optical circuit regardless of a polarization state of the light to be used at the time of adjusting the position of the optical fiber array.

A method for aligning the optical fiber array 802 using the optical component 901 or the optical component 1001 of the present embodiment can be performed by the same method as the alignment method using the optical component of the second embodiment. Specifically, in the second step described above, light is incident from the second optical fiber connected to the optical output port of the optical circuit, and the position of the optical fiber block in the XY direction is adjusted so that the light intensity is maximized. In this event, the intensity of the light incident on the light output port of the optical circuit is the same as that in the alignment method using the optical component of the second embodiment described above, except that the light intensity is monitored by the fiber alignment optical receivers 620₁ and 620₂ in the case of using the optical component 901 and is monitored by the fiber alignment optical receiver 1020 in the case of using the optical component 1001.

Thus, in the alignment of the optical component and the optical fiber array according to the third embodiment, it is not necessary to control and operate the optical modulator at the time of alignment, so that the optical fiber array can be aligned using a simple alignment method.

### Fourth Embodiment

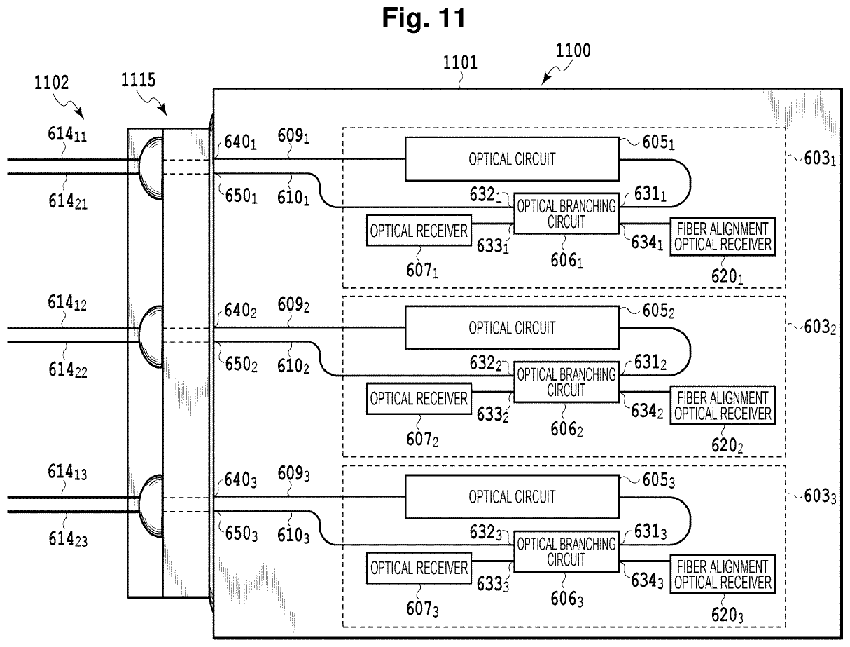

Finally, a fourth embodiment of the present disclosure will be described with reference to FIG. 11. FIG. 11 is a view illustrating an arrangement configuration of a module 1100 including an optical component 1101 in which a plurality of optical circuit units 603 in FIG. 6 are integrated into multiple channels and an optical fiber array 1102 including optical fibers 614₁₁ to 614₁₃ and 614₂₁ to 614₂₃ connected to the optical waveguides 609₁ to 609₃ and 610₁ to 610₃ of the integrated plurality of optical circuit units 603₁ to 603₃. Such an optical component 1101 for multichannel transmission is useful from the viewpoint of reduction in size and cost of the optical transceiver.

In a case where the optical circuits 605₁ to 605₃, which are a plurality of optical transmitters, are integrated as in the present embodiment, the optical branching circuits 606₁ to 606₃ and the optical receivers 607₁ to 607₃ are arranged on the output side of the modulator, which is an optical circuit included in each of the optical circuit units 603₁ to 603₃, in order to monitor the optical power output from each of the optical transmitters. Thus, similarly to the first embodiment illustrated in FIG. 6, by using the optical branching circuits 606₁ to 606₃, it is possible to monitor the intensity of the light incident on the optical waveguides 610₁ to 610₃ connected to the optical output ports 650₁ to 650₃ by the fiber alignment optical receivers 620₁ to 620₃. In the present embodiment, as illustrated in FIG. 11, the fiber alignment optical receivers 620₁ to 620₃ are connected to the fourth ports 634₁ to 634₃ of the optical branching circuits 606₁ to 606₃ respectively included in the optical circuit units 603₁ to 603₃. As described above, in the alignment of the optical fiber array, it is necessary to independently adjust the positions of the two optical fibers constituting the optical fiber array. In the fourth embodiment, it is possible to monitor light intensity of light input to any of the optical fibers constituting the optical fiber array 1102.

Alignment procedure using the optical component of this embodiment will be described with reference to FIG. 7 as follows. In a first step, alignment is performed using an optical fiber connected to an optical output port of a first optical circuit, and in a second step, alignment is performed using an optical fiber connected to an optical output port of a second optical circuit. In this case, the first step and the second step are similar to the second step of the alignment method of the first embodiment.

Specifically, the first step that is a step of aligning the first optical fiber is as follows. Any one optical fiber is selected from the optical fibers 614₂₁ to 614₂₃, and light is made incident thereon. While the intensity of the light incident on any of the optical fibers 614₂₁ to 614₂₃ is monitored by a photocurrent of any of the fiber alignment optical receivers 620₁ to 620₃, an optical fiber block 1115 is moved in the XY direction along the connection end face of the optical component 1101 and adjusted to a position where the light intensity is maximized. The other details of the first step are similar to those of the step described above. The second step of aligning the second optical fiber is as follows. Any one optical fiber is selected from the remaining two optical fibers 614₂₁ to 614₂₃, and light is made incident thereon. While the intensity of the light incident on any one of the optical fibers 614₂₁ to 614₂₃ is monitored by a photocurrent of any one of the fiber alignment optical receivers 620₁ to 620₃, the optical fiber block 1115 is moved only in the XY direction from a state in which alignment is performed in the first step, and adjustment is performed so that the light intensity is maximized. The other details of the second step are similar to those of the step described above. Note that, from the viewpoint of accuracy, it is desirable to use two optical fibers that are farthest from each other as the optical fibers to be used for alignment in the first step and the second step. In other words, in the alignment using the optical component 1101 and the optical fiber block 1115 of the present embodiment, it is desirable to perform the alignment using 614₂₁ and 614₂₃. The other steps (the third step and the fourth step) are similar to the steps described in FIG. 7.

As described in the first embodiment, the intensity of the light input to the optical waveguide 609 of the optical circuit 605 can be monitored by controlling the optical circuit to operate, but the control of the optical circuit is complicated. In the second embodiment, the optical fiber array is adjusted in the XY direction and the θ-axis rotation direction by adjusting the positions of the optical fiber and the optical waveguide that can be monitored using the optical reception circuit. Also in monitoring using the optical reception circuit, it is necessary to control the optical reception circuit to operate. On the other hand, the fiber alignment optical receiver is specialized for alignment that is not used in normal use, and thus, it is not necessary to control the optical circuit or the optical reception circuit for monitoring the light intensity. Thus, the optical component 1101 including the plurality of optical circuit units including the fiber alignment optical receivers can easily perform the XY adjustment and the θ adjustment of the optical fiber array without controlling the optical circuit.

FIG. 11 illustrates a configuration in which the fiber alignment optical receivers 620₁ to 620₃ are respectively installed in the fourth ports 634₁ to 634₃ of the optical branching circuits 606₁ to 606₃ of all the optical circuit units. However, if the fiber alignment optical receivers are installed in the optical branching circuits of at least two of the plurality of optical circuit units, XY adjustment and θ adjustment of the optical fiber array can be performed.

Here, a plurality of integrated optical circuit units illustrated in FIG. 6 has been described as an example, but the plurality of integrated optical circuit units may be the optical circuit unit 803 in FIG. 8, the optical circuit unit 903 in FIG. 9, or the optical circuit unit 1003 in FIG. 10. Furthermore, even in an optical component in which a plurality of the optical transmission circuits 905 of FIG. 9 and a plurality of the optical transmission circuits 1005 of FIG. 10 are integrated, XY adjustment and θ adjustment of the optical fiber array can be easily performed similarly without controlling the optical circuit.

### Advantageous Effects of Invention

According to the present disclosure, an excellent effect is provided that it is possible to implement an optical component that enables easy optical fiber array connection with low loss without using an optical branching circuit for alignment, an optical circuit, and an optical fiber.

### Industrial Applicability

It is possible to provide an optical component that makes it possible to accurately and easily align an optical component and an optical fiber array connected to the optical component.

### REFERENCE SIGNS LIST

101, 201, 301, 401, 501 Optical component
601, 801, 901, 1001, 1101 Optical component
102, 402, 602, 802, 1102 Optical fiber array
103, 504, 603, 803, 903, 1003 Optical circuit unit
104, 804 Optical reception circuit
105, 505 Optical modulator
605 Optical circuit
106, 506, 606 Optical branching circuit
107, 507, 607 Optical receiver
613 Connection end face
114, 614, 814 Optical fiber
115, 430, 615, 815, 1115 Optical fiber block
620, 1020 Fiber alignment optical receiver
631 First port
632 Second port
633 Third port
634 Fourth port
640, 830 Optical input port
650 Optical output port
905, 1005 Optical transmission circuit
915 Polarization synthesizer

1-6. (canceled)

7. An optical component comprising a connection end face to which an optical fiber array is connected and an optical circuit unit, wherein
the connection end face includes:
an optical input port; and
an optical output port, and
the optical circuit unit includes:
an optical circuit connected to the optical input port;
an optical branching circuit including a first port connected to the optical circuit, a second port connected to the optical output port, a third port adjacent to the second port, and a fourth port adjacent to the first port, the optical branching circuit configured to branch light input from the first port and output the light from the second port and the third port, and output light input from the second port from the fourth port;
a first optical receiver connected to the third port of the optical branching circuit; and
a second optical receiver connected to the fourth port of the optical branching circuit.

8. The optical component according to claim 7, wherein
the optical circuit includes a first optical modulator and a second optical modulator,
the optical branching circuit includes a first optical branching circuit and a second optical branching circuit corresponding to the first optical modulator and the second optical modulator, respectively, and
the optical circuit unit further includes a polarization synthesizer that polarization-synthesizes light from the first optical branching circuit and light from the second optical branching circuit.

9. The optical component according to claim 8, wherein
the second optical receiver includes an optical receiver connected to the fourth port of the first optical branching circuit and another optical receiver connected to the fourth port of the second optical branching circuit.

10. The optical component according to claim 8, wherein the first optical branching circuit and the second optical branching circuit are connected to the second optical receiver in common.

11. The optical component according to claim 7, wherein
the optical circuit unit further includes an optical reception circuit, and
the connection end face further includes an optical input port for an optical reception circuit connected to the optical reception circuit.

12. The optical component according to claim 7, wherein
the connection end face includes a plurality of optical input ports and a plurality of optical output ports, and
the optical circuit unit includes a plurality of the optical circuit units corresponding to the plurality of optical input ports and the plurality of optical output ports.

13. The optical component according to claim 8, wherein
the connection end face includes a plurality of optical input ports and a plurality of optical output ports, and
the optical circuit unit includes a plurality of the optical circuit units corresponding to the plurality of optical input ports and the plurality of optical output ports.

14. The optical component according to claim 9, wherein
the connection end face includes a plurality of optical input ports and a plurality of optical output ports, and
the optical circuit unit includes a plurality of the optical circuit units corresponding to the plurality of optical input ports and the plurality of optical output ports.

15. The optical component according to claim 10, wherein
the connection end face includes a plurality of optical input ports and a plurality of optical output ports, and
the optical circuit unit includes a plurality of the optical circuit units corresponding to the plurality of optical input ports and the plurality of optical output ports.

16. The optical component according to claim 11, wherein
the connection end face includes a plurality of optical input ports and a plurality of optical output ports, and
the optical circuit unit includes a plurality of the optical circuit units corresponding to the plurality of optical input ports and the plurality of optical output ports.

17. A method for aligning an optical fiber array with an optical component, the method comprising:
providing an optical component including a connection end face having an optical input port and an optical output port, and an optical circuit unit having an optical circuit connected to the optical input port, an optical branching circuit including a first port connected to the optical circuit, a second port connected to the optical output port, a third port adjacent to the second port, and a fourth port adjacent to the first port, a first optical receiver connected to the third port, and a second optical receiver connected to the fourth port;
aligning a first optical fiber of the optical fiber array by inputting light from the first optical fiber to the optical input port, monitoring light intensity using the first optical receiver, and adjusting a position of an optical fiber block in an XY direction to maximize the light intensity;
aligning a second optical fiber of the optical fiber array by inputting light from the second optical fiber to the optical output port, monitoring light intensity using the second optical receiver, and adjusting the position of the optical fiber block in the XY direction to maximize the light intensity;
calculating a deviation amount in a θ-axis rotation direction based on a relative position between the position obtained in the aligning of the first optical fiber and the position obtained in the aligning of the second optical fiber; and
rotating the optical fiber block by the deviation amount in the θ-axis rotation direction.

18. The method according to claim 17, wherein the optical circuit unit further includes an optical reception circuit connected to an optical input port for an optical reception circuit, and the aligning of the first optical fiber comprises inputting light from the first optical fiber to the optical input port for the optical reception circuit and monitoring light intensity using the optical reception circuit.

19. The method according to claim 17, further comprising repeating the aligning of the first optical fiber, the aligning of the second optical fiber, the calculating, and the rotating a plurality of times to achieve higher accuracy positioning.

20. The method according to claim 17, wherein the optical fiber array includes a plurality of optical fibers, and the first optical fiber and the second optical fiber are selected to be farthest apart from each other among the plurality of optical fibers to improve alignment accuracy.

21. The method according to claim 17, wherein the optical component includes a plurality of optical circuit units each having an optical branching circuit with a second optical receiver, and the method further comprises selecting any two optical fibers from optical fibers connected to optical output ports of different optical circuit units for the aligning of the first optical fiber and the aligning of the second optical fiber.

22. An optical component comprising an optical branching circuit, the optical component comprising:
a connection end face having an optical input port and an optical output port; and
an optical circuit unit including: an optical circuit connected to the optical input port;
the optical branching circuit having a first port configured to receive light from the optical circuit, a second port adjacent to a third port and configured to output a first portion of the light received from the first port to the optical output port, the third port configured to output a second portion of the light received from the first port to a first optical receiver for monitoring optical power, and a fourth port adjacent to the first port and configured to receive light input from the second port and output the light to a second optical receiver for fiber alignment;
the first optical receiver connected to the third port; and the second optical receiver connected to the fourth port, wherein the optical branching circuit is configured as a two-input two-output branching circuit that enables monitoring of light intensity from both an optical circuit output direction and an optical output port input direction without requiring additional branching circuits for alignment.

23. The optical component according to claim 22, wherein the optical branching circuit may be implemented as a multimode interference coupler or a directional coupler.

24. The optical component according to claim 22, wherein the optical branching circuit is configured to branch approximately 95% of light received from the first port to the second port and approximately 5% of light received from the first port to the third port.

25. The optical component according to claim 22, wherein the second optical receiver may include a germanium-based integrated optical receiver having reduced reflection characteristics, and a boundary surface between an optical waveguide connected to the fourth port and the second optical receiver is inclined relative to a light propagation direction to minimize reflected light.
